(19) United States
(12) Patent Application Publication
(10) Pub. No.: US 2012/0298570 A1
(43) Pub. Date: Nov. 29, 2012

(54) FILTRATION APPARATUS AND WATER TREATMENT APPARATUS

(75) Inventors: Masanobu Osawa, Tokyo (JP); Keijirou Tada, Tokyo (JP); Shigeru Sato, Tokyo (JP)

(73) Assignee: KURITA WATER INDUSTRIES LTD., Tokyo (JP)

(21) Appl. No.: 13/577,442

(22) PCT Filed: Mar. 28, 2011
(86) PCT No.: PCT/JP2011/057584

§ 371 Date: Aug. 7, 2012

(30) Foreign Application Priority Data
Mar. 31, 2010 (JP) 2010-081549

(51) Int. Cl. B01D 29/07; B01D 29/66; C02F 1/52; C02F 1/44; B01D 36/02

(52) U.S. Cl. 210/202; 210/437; 210/252

(57) ABSTRACT

A filtration apparatus 10, includes: a filter body 4 formed by spirally winding a sheet-shaped member; and a filtration tank 1 through which water to be treated is passed, and into which the filter body 4 is charged such that the axis of the filter body 4 extends along the direction of water passage, wherein the sheet-shaped member is composed of a sheet-shaped mesh sheet 5 having holes through which the water to be treated passes, and a sheet-shaped spacer 6 through which the water to be treated passes with difficulty as compared with the mesh sheet 5, the sheet surfaces of the mesh sheet 5 and the spacer 6 being superposed on each other.

### TECHNICAL FIELD

This invention relates to a filtration apparatus for treating water to be treated, the water containing suspended matter or the like, such as industrial water, city water, well water, river water, lake water or industrial waste water; and a water treatment apparatus using the filtration apparatus. The invention relates, in particular, to a filtration apparatus which can be preferably used in a stage preceding a reverse osmosis membrane apparatus or the like.

### BACKGROUND ART

Methods for treating water to be treated, such as industrial water, city water, well water, river water, lake water or industrial waste water, include a method which comprises, for example, adding an inorganic flocculant and a polymer flocculant of anionic nature or the like to the water to be treated, thereby performing flocculation to adsorb or coagulate suspended matter contained in the water to be treated, followed by carrying out sand filtration or dissolved air floatation to remove the suspended matter. The sand filtration or dissolved air floatation, however, poses the problem that the required apparatus is upsized. If the turbidity of the water to be treated is high, moreover, there is a possibility that the removal of the suspended matter will be insufficient.

To solve such problems, the application of membrane separation means, concretely, an ultrafiltration membrane (UF) apparatus or a microfiltration membrane (MF) apparatus, as a filtration apparatus has recently become widespread. The ultrafiltration membrane apparatus or the microfiltration membrane apparatus, however, involves the problem that clogging with suspended materials, inorganic substances or organic substances occurs, and the problem that the cost of the membrane is high.

To produce pure water or the like, the technology of treating water to be treated by means of a reverse osmosis membrane (RO) apparatus is available. With the reverse osmosis apparatus, there is need to use water to be treated, having a certain degree of cleanliness, which has been treated with the aforementioned sand filtration, dissolved air floatation, ultrafiltration apparatus, microfiltration membrane apparatus or the like in the preceding stage. The sand filtration, dissolved air floatation, ultrafiltration apparatus, microfiltration membrane apparatus or the like, however, faces problems, such as the insufficient removal of suspended matter or the occurrence of clogging, as stated above.

A disclosure is made of an apparatus for producing electric power plant make-up water in which a filtration apparatus using a bundle of long fibers as a filter is provided upstream of a reverse osmosis membrane apparatus (see Patent Document 1). Even with this apparatus, the problems arise that the clogging of the reverse osmosis membrane apparatus or the filtration apparatus occurs, and that the quality of treated water deteriorates.

### PRIOR ART DOCUMENTS

### Patent Documents

Patent Document 1: JP-A-6-134490

### SUMMARY OF THE INVENTION

### Problems to be Solved by the Invention

The present invention has been accomplished in the light of the above-mentioned circumstances. It is an object of the invention to provide a filtration apparatus which obtains clear treated water suppliable to a reverse osmosis membrane apparatus or the like, is minimally clogged, and is inexpensive; and a water treatment apparatus using the filtration apparatus.

### Means for Solving the Problems

The present inventors conducted in-depth studies in order to attain the above object, and have found that this object can be attained by the following method: A spirally wound sheet-shaped member is used as a filter for trapping suspended matter. The sheet-shaped member comprises a sheet-shaped mesh sheet having holes through which water to be treated passes, and a sheet-shaped spacer through which the water to be treated passes with difficulty as compared with the mesh sheet, the sheet surface of the spacer and the sheet surface of the mesh sheet being superposed on each other. A filtration apparatus having the filter is configured to have a structure in which the water to be treated is passed so as to cross the mesh sheet longitudinally. Based on this finding, the inventors have completed the present invention.

That is, the filtration apparatus of the present invention comprises a filter body formed by spirally winding a sheet-shaped member; and a filtration tank through which water to be treated is passed, and into which the filter body is charged such that the axis of the filter body extends along the direction of water passage, the sheet-shaped member being composed of a sheet-shaped mesh sheet having holes through which the water to be treated passes, and a sheet-shaped spacer through which the water to be treated passes with difficulty as compared with the mesh sheet, the sheet surfaces of the mesh sheet and the spacer being superposed on each other.

The filter body is preferably the sheet-shaped member spirally wound around a core material.

The spacer may be a nonwoven fabric formed from fibers having a diameter of 0.1 to 100 μm.

The spacer may also be formed from activated carbon fibers having a diameter of 0.1 to 100 μm.

Further, the spacer is preferably composed of a nonwoven fabric formed from fibers having a diameter of 0.1 to 100 μm, and a water-impermeable sheet which is not permeable to the water to be treated.

The mesh sheet is preferably formed from fibers having a diameter of 0.1 to 0.6 mm.

Another aspect of the present invention lies in a water treatment apparatus characterized by having a reverse osmosis membrane apparatus in a stage succeeding the above filtration apparatus.

It is preferred to have, in a stage preceding the filtration apparatus, a macrofiltration apparatus comprising a macro-filter charged into a macrofiltration tank such that the void content of a filtration portion during water passage becomes 50 to 95%, the macro-filter having string-shaped suspended matter trapping portions and trapping suspended matter contained in the water to be treated which is being passed.

The macrofiltration apparatus and the filtration apparatus may be accommodated in a single vessel, and the macrofiltration apparatus and the filtration apparatus may be integrated.

Further, it is preferred to have, in the stage preceding the filtration apparatus, flocculation means including a reaction tank into which the water to be treated is introduced, and flocculant introduction means which introduces a flocculant in the reaction tank or in the stage preceding the reaction tank to add the flocculant to the water to be treated.

It is preferred to further have cleaning fluid introduction means which introduces a cleaning fluid or a liquid mixture of the cleaning fluid and air at an arbitrary frequency and in a direction opposite to a direction during treatment.

### Effects of the Invention

The filtration apparatus of the present invention comprises a filter body formed by spirally winding a sheet-shaped member; and a filtration tank through which water to be treated is passed, and into which the filter body is charged such that the axis of the filter body extends along the direction of water passage, the sheet-shaped member being composed of a sheet-shaped mesh sheet having holes through which the water to be treated passes, and a sheet-shaped spacer through which the water to be treated passes with difficulty as compared with the mesh sheet, the sheet surfaces of the mesh sheet and the spacer being superposed on each other. Thus, there can be provided a filtration apparatus which obtains clear treated water, which can suppress the clogging of the apparatus in the succeeding stage and the filtration apparatus itself, and which is inexpensive. By providing this filtration apparatus in the stage preceding the reverse osmosis membrane apparatus or the like, therefore, water to be treated can be treated preferably for a long period of time. This filtration apparatus can also be configured as a water treatment apparatus having the flocculation means in the preceding stage. If water is treated at a high rate or if the turbidity of the water to be treated is high, there tend to be the problems, in particular, that clear treated water is difficult to obtain, and that clogging occurs in the filtration apparatus or the membrane separation means such as the reverse osmosis membrane apparatus provided in the succeeding stage, with the result that satisfactory treatment of water cannot be performed. By providing the macrofiltration apparatus having a predetermined void content in the stage preceding the filtration apparatus, however, the following effects are produced even in the case of high speed treatment or highly turbid water to be treated: Clear treated water is obtained, clogging of the reverse osmosis membrane apparatus or the like, or the filtration apparatus can be further suppressed, and water treatment can be performed satisfactorily.

### BRIEF DESCRIPTION OF THE DRAWINGS

FIG. 1 is a longitudinal sectional view showing the configuration of a filtration apparatus according to Embodiment 1.

FIG. 2 is a transverse sectional view of the filtration apparatus according to Embodiment 1.

FIG. 3 is a perspective view showing a filter according to Embodiment 1.

FIGS. 4(a), 4(b) are enlarged views of essential parts of a mesh sheet according to Embodiment 1.

FIG. 5 is a schematic system diagram of an example of a water treatment apparatus according to Embodiment 2.

FIG. 6 is a view showing the configuration of the example of the water treatment apparatus according to Embodiment 2.

FIG. 7 is a schematic system diagram of another example of the water treatment apparatus according to Embodiment 2.

FIG. 8 is a schematic system diagram of still another example of the water treatment apparatus according to Embodiment 2.

FIG. 9 is a schematic system diagram of an additional example of the water treatment apparatus according to Embodiment 2.

FIG. 10 is a sectional view showing the configuration of an example of a water treatment apparatus according to Embodiment 3.

FIG. 11 is a sectional view showing the configuration of a macrofiltration apparatus according to Embodiment 3.

FIG. 12 is an enlarged view of essential parts of the macrofiltration apparatus according to Embodiment 3.

FIG. 13 is a view showing an example of a suspended matter trapping portion of the macrofiltration apparatus according to Embodiment 3.

FIG. 14 is a view showing a method for measuring the differential pressure of a reverse osmosis membrane.

FIG. 15 is a view showing the results of measurement of the differential pressure of the reverse osmosis membrane.

FIG. 16 is a schematic system diagram of a water treatment apparatus according to a reference example.

### MODE FOR CARRYING OUT THE INVENTION

The present invention will be described in detail below based on its embodiments.

### Embodiment 1

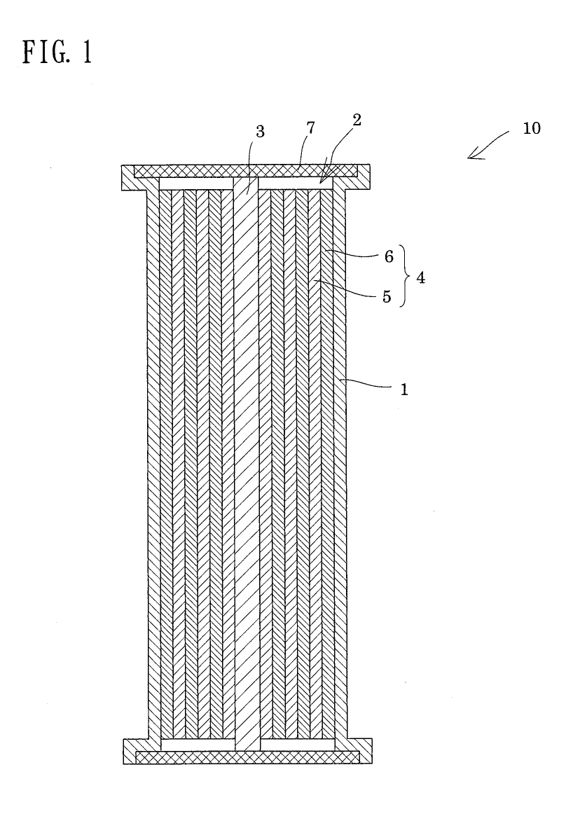

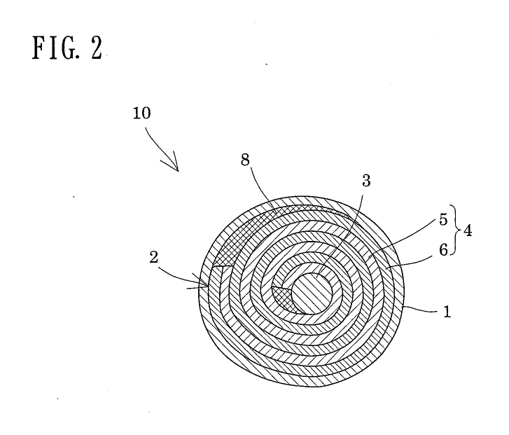

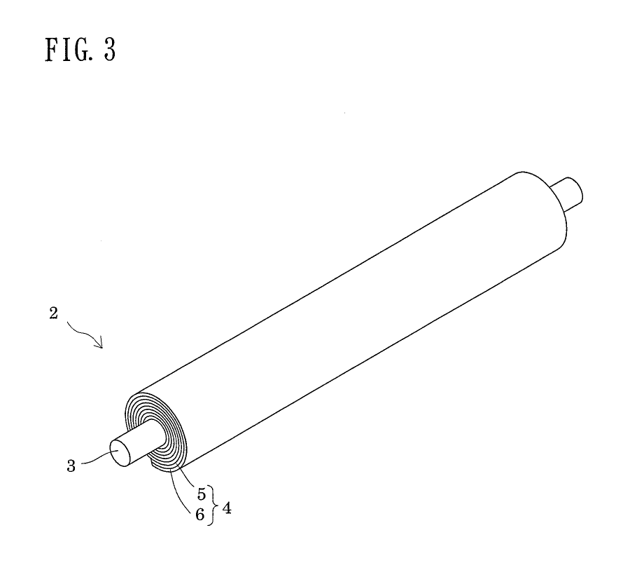

FIG. 1 is a longitudinal sectional view, in the direction of water passage of water to be treated, showing the configuration of a filtration apparatus according to Embodiment 1 of the present invention. FIG. 2 is a transverse sectional view of the filtration apparatus. FIG. 3 is a perspective view showing a filter of the filtration apparatus.

As shown in FIGS. 1 and 2, a filtration apparatus 10 has a tubular filtration tank 1 through which water to be treated is passed, and a filter 2 for trapping suspended matter contained in the water to be treated which is being passed. The filter 2 has a core material 3 connected to both ends in the direction of water passage of the filtration tank 1, and a filter body 4 composed of a sheet-shaped member wound spirally around the core material 3. The sheet-shaped member comprises a sheet-shaped mesh sheet 5 having holes through which water to be treated passes, and a sheet-shaped spacer 6 through which the water to be treated passes with difficulty as compared with the mesh sheet, the sheet surfaces of the spacer 6 and the mesh sheet 5 being superposed on each other.

At both ends, in the direction of water passage, of the filtration tank 1, circular plates 7 of resin or the like are provided which have a plurality of holes enough to allow free passage therethrough of water to be treated, the water containing suspended matter. Both ends of the core material 3 are fixed to the center of each plate 7. The filter 2 is charged into the entire filtration tank 1 such that the axis of the filter body 4 extends along the direction of water passage of the water to be treated. Clearance between the inner wall of the filtration tank 1 and the outer periphery of the filter body 4, and clearance near the core material 3 are filled with a water-impermeable member 8, such as an adhesive, which does not allow passage of water to be treated. Thus, the water to be treated cannot pass through these clearances. The axis of the filter body 4 is the center of the spiral of the filter body 4 wound spirally and, in the present embodiment, corresponds to the core material 3.

When the water to be treated is passed through the filtration apparatus 10 of the above configuration, most of the water to be treated passes through the holes of the mesh sheet 5, and crosses the mesh sheet 5 nearly longitudinally, that is, passes through the mesh sheet 5 in its planar direction, because the spacer 6 is less permeable to the water to be treated than the mesh sheet 5. On this occasion, the suspended matter contained in the water to be treated is trapped by the mesh sheet 5, and the water to be treated, from which the suspended matter has been removed, is discharged from the filtration tank 1. The filtration apparatus 10, as described above, is configured such that the water to be treated pass therethrough so as not to cross the mesh sheet 5, which has the holes passed through by the water to be treated and which can trap the suspended matter, transversely in the thickness direction, but to cross the mesh sheet 5 longitudinally. By this configuration, clear treated water is obtained. Thus, the filtration apparatus 10 can be used, in a stage preceding a reverse osmosis membrane (RO) apparatus, in place of a membrane separation apparatus such as an ultrafiltration membrane (UF) apparatus or a microfiltration membrane (MF) apparatus, and can suppress the clogging of the reverse osmosis membrane apparatus. Since the filtration apparatus 10 does not rely on filtration using a membrane, as does the ultrafiltration membrane apparatus or the microfiltration membrane apparatus, it minimally clogs and is inexpensive.

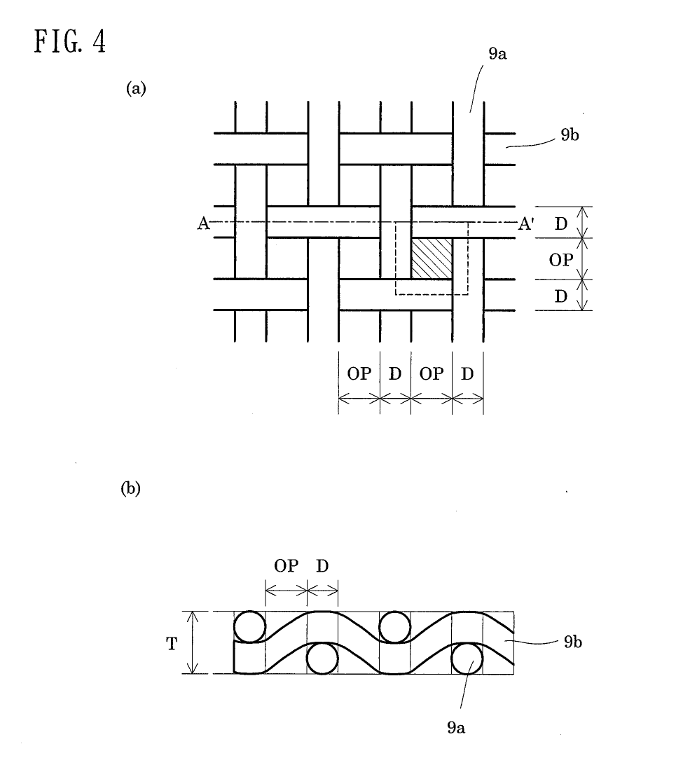

The mesh sheet 5 may be one which has holes allowing the passage of water to be treated, and which can remove to a desired degree the suspended matter contained in the water to be treated, so that the mesh sheet 5 is not restricted. However, a woven fabric formed from warp threads 9a and weft threads 9b as shown, for example, in FIGS. 4(a) and 4(b) is named. FIGS. 4(a), 4(b) show the mesh sheet 5 in an enlarged plan view of its essential parts (FIG. 4(a)) and in a sectional view taken on line A-A′ of FIG. 4(a) (i.e., FIG. 4(b)).

The distance between the adjacent warp threads 9a or the adjacent weft threads 9b of the mesh sheet 5, namely, the opening (indicated as OP in FIGS. 4(a), 4(b)), is preferably of the order of 200 to 4,000 μm. The size of the holes (indicated by hatch lines in FIG. 4(a)), namely, the space factor in a plan view of the mesh sheet 5 (i.e., opening area), is preferably of the order of 40 to 90%. The height of the intersection (thickness designated as T in FIG. 4(b)) is preferably 500 to 1200 μm. As a concrete commercial product, a 100-hole to 8-hole product (product of NBC), for example, may be used. The product with these dimensions can remove the suspended matter particularly preferably. Ina reverse osmosis membrane apparatus, for example, a spiral-type reverse osmosis membrane apparatus composed of a spirally wound reverse osmosis membrane, a mesh sheet with an intersection height, usually, of the order of 0.65 to 1.2 mm is used as a raw water flow path spacer. Thus, if the filtration apparatus is used as a filtration apparatus in the stage preceding the reverse osmosis membrane apparatus, namely, as a filtration apparatus for supplying treated water to the reverse osmosis membrane apparatus, thereby preventing the clogging of the reverse osmosis membrane apparatus, the filtration apparatus preferably uses the mesh sheet having a smaller intersection height than that of the reverse osmosis membrane apparatus.

The diameters D of the fibers constituting the warp thread 9a and the weft thread 9b are each preferably 0.1 to 0.6 mm, more preferably 0.1 to 0.4 mm. In order that the water to be treated can cross the threads nearly longitudinally, it is necessary to form the holes, through which the water to be treated is passed, with the use of fibers having a certain degree of thickness, although the thickness depends on the turbidity of, or the amount of treatment of, the water to be treated. If the fibers are too thick, the resulting holes become too large to remove the suspended matter.

Examples of the material for the thread or the like constituting the mesh sheet 5 are synthetic resins, such as polyolefin, polyester, nylon and polyvinylidene fluoride (PVDF), and metal fibers. From the points of view of chemical resistance and economy, polyolefin is preferred. In FIGS. 4(a), 4(b), the woven fabric is taken as an example, but there may be used a nonwoven fabric formed from fibers and having relatively large holes.

The spacer 6 is not limited, as long as it is in the shape of a sheet through which the water to be treated passes with difficulty as compared with the mesh sheet 5. For example, it may be a water-impermeable sheet free from holes and allowing no passage of the water to be treated; a nonwoven fabric or the like formed from fibers with a diameter of the order of 0.1 to 100 μm, preferably 0.5 to 30 μm; or these materials superposed by a method such as lamination or integral molding by thermal fusion. If the spacer 6 is the water-impermeable sheet which does not allow passage of the water to be treated, the water to be treated can be brought into uniform contact with the mesh sheet 5. Thus, the spacer 6 is preferably one having the water-impermeable sheet. If the nonwoven fabric is used as the spacer 6, the fluffed sites of the surface of the nonwoven fabric can trap the suspended matter contained in the water to be treated, so that the suspended matter trapping properties of the filtration apparatus 10 can be enhanced. Thus, the spacer is preferably composed of the nonwoven fabric and the water-impermeable sheet.

Examples of the material for the spacer 6 are polyolefin, polyester, nylon, polyvinylidene fluoride (PVDF), metal fiber, and activated carbon fiber. From the viewpoints of chemical resistance and economy, polyolefin is preferred. From the aspects of being able to perform the reduction of NaClO, etc. contained in the water to be treated, and to obviate the need for an apparatus such as an activated carbon tower, activated carbon fibers are preferred.

There are no limitations on the form in which the mesh sheet 5 and the spacer 6 are superposed on each other; the sheet surfaces thereof may be laminated together, or they may be integrally molded by heat fusion. The size of the mesh sheet 5 and the size of the spacer 6 need not be the same, but preferably, they are nearly the same for uniform treatment of the water to be treated. The lengths in the direction of water passage of the mesh sheet and the spacer 6 are advisably, for example, of the order of 200 to 1,000 mm, although these lengths depend on the turbidity of the water to be treated, the amount of its treatment, and the desired turbidity of treated water.

The material for the core material 3 around which the sheet member composed of the mesh sheet 5 and the spacer 6 laminated together is not restricted, and a plastic, a metal or the like can be used. From the viewpoint of economy, polyvinyl chloride piping (CVP piping) is preferred. Nor is the shape 3 of the core material restricted, and its shape may be columnar or prismatic. No limitation is imposed on the method of winding the sheet member around the core material 3. For example, the method may comprise fixing an end of the sheet member to the core material 3 with the use of an adhesive or the like, and rolling up the sheet member, with the core material 3 positioned in the center of the resulting roll, such that the roll has an arbitrary diameter depending on the amount of treatment, the turbidity, etc. of the water to be treated.

There are no limitations on the filtration tank 1. For example, its material may be stainless steel or fiber-reinforced plastic (FRP), and its size can be represented by a diameter of 100 to 1,000 mm and a height of 200 to 1,000 mm, as long as its shape is a hollow cylindrical (tubular) shape. In FIG. 1, the tubular filtration tank 1 is illustrated, but the tubular shape is not limitative; a shape which allows the passage of water, namely, a hollow shape, is acceptable, and a prismatic shape having a hollow inside, for example, may be adopted.

Examples of the water to be treated are industrial water, city water, well water, river water, lake water, industrial waste water (particularly, bioremediation water resulting after bioremediation of waste water from plants), and water obtained by adding a flocculant to any of these types of water for flocculation.

In FIG. 1, the filter 2 used is one having three turns of the filter body 4 wound about the core material 3. However, the number of turns wound is not limited, and may be adjusted, as appropriate, depending on the amount of treatment, the turbidity, etc. of the water to be treated. Thus, the filter 2 may be only a single turn of the filter body 4 wound, but the larger the number of turns wound is, the more easily the shape of the mesh sheet 5 can be held by the spacer 6. This results in the advantage that the water to be treated can uniformly cross the mesh sheet 5 longitudinally, thus stabilizing water treatment.

In FIG. 1, moreover, the filter 2 is composed of the filter body 4 wound round the core material 3, but the core material 3 need not be present. For example, the filter 2 may be composed of the filter body 4 alone, if the shape of the mesh sheet 5 during water passage can be held by the spacer 6 or the like, and the water to be treated can pass through the mesh sheet 5 in the planar direction (can cross it longitudinally).

In FIG. 1, moreover, the filter 2 is charged into the filtration tank 1 of a hollow cylindrical shape to construct the filtration apparatus 10. However, a sheet of FRP or the like may be wound round the filter 2, followed by joining them together to prevent leakage of the water to be treated. In this manner, the filtration apparatus 10 may be constructed. Besides, the spacer 6 may be formed from a water-impermeable material to avoid leakage of the water to be treated, whereby the spacer 6 may concurrently serve as the filtration tank 1.

### Embodiment 2

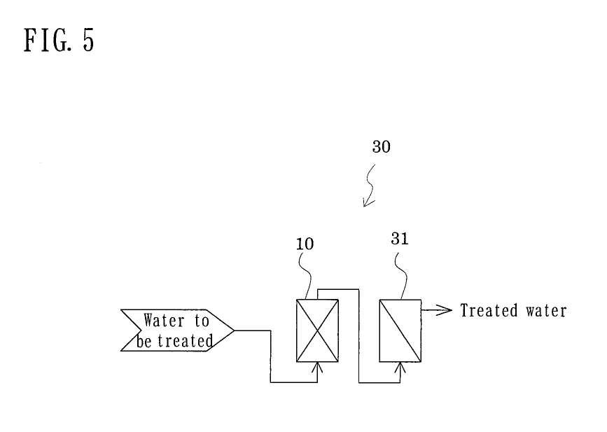

FIG. 5 is a schematic system diagram of a water treatment apparatus according to Embodiment 2 of the present invention. The same members as those in Embodiment 1 are assigned the same numerals as in Embodiment 1, and duplicate explanations are omitted.

As shown in FIG. 5, a water treatment apparatus 30 has a reverse osmosis membrane apparatus 31 provided in a stage succeeding (downstream of) the filtration apparatus 10 of Embodiment 1, the reverse osmosis membrane apparatus 31 being adapted to perform membrane separation of water to be treated, with the use of a reverse osmosis membrane.

With such a water treatment apparatus 30, the water to be treated (raw water) is introduced into the filtration apparatus 10 as the first step. The water to be treated, which has been introduced into the filtration apparatus 10, crosses the mesh sheet 5 longitudinally, whereby suspended matter contained in the water to be treated is removed to some extent. Clear treated water discharged from the filtration apparatus 10 is supplied to the reverse osmosis membrane apparatus 31 located in the succeeding stage, where it is subjected to membrane separation by the reverse osmosis membrane. In the present embodiment, the filtration apparatus 10 of Embodiment 1 is used, so that treated water discharged from the filtration apparatus 10 is clear. Thus, the filtration apparatus 10 can be used, in the stage preceding the reverse osmosis membrane apparatus 31, instead of a membrane separation apparatus such as an ultrafiltration membrane apparatus or a microfiltration membrane apparatus. Since the filtration apparatus 10, unlike the UF apparatus or the MF apparatus, does not involve filtration using a membrane, it is minimally clogged and is inexpensive.

In the reverse osmosis membrane apparatus 31 provided in the stage succeeding the filtration apparatus 10, it is preferred that the cross-sectional area of a water flow path for water to be treated be larger than the cross-sectional area, in the direction of water passage of the water to be treated, of the mesh sheet 5. With the spiral type reverse osmosis membrane apparatus 31, for example, it is preferred that the width of the raw water flow path be larger than the height of the intersection of the mesh sheet 5. The shape of the reverse osmosis membrane apparatus 31 is not restricted. However, a so-called spiral type reverse osmosis membrane apparatus 31 of a shape in which a reverse osmosis membrane shaped like a sack is wound round a hollow core material having water passage holes in a side surface thereof is preferred, because this type of apparatus is easily adapted for upsizing. In particular, it is preferred to use the spiral type reverse osmosis membrane apparatus having the same diameter as that of the filtration apparatus 10. If the spiral type reverse osmosis membrane apparatus 31 is used, treated water resulting after the membrane separation of impurities by the reverse osmosis membrane is discharged from the hollow core material, while so-called concentrated water containing large amounts of impurities which have not been membrane-separated by the reverse osmosis membrane is discharged from other parts than the core material.

Instead of the reverse osmosis membrane apparatus 31, a membrane separation means, such as a microfiltration membrane (MF membrane), an ultrafiltration membrane (UF membrane) or a nano-filtration membrane (NF membrane), may be provided in the stage succeeding the filtration apparatus 10 to construct a water treatment apparatus.

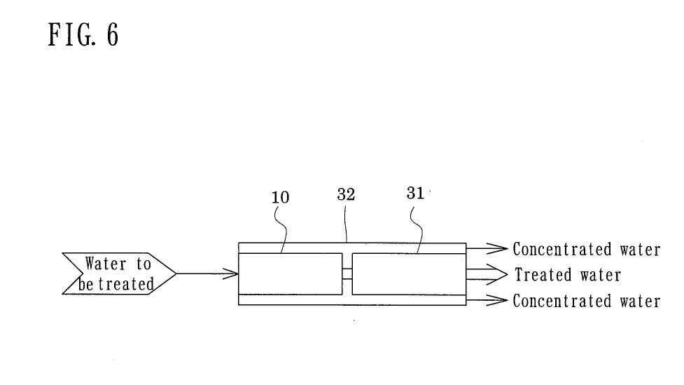

In FIG. 5, the filtration apparatus 10 and the reverse osmosis membrane apparatus 31 are separately provided to construct the water treatment apparatus. However, this is not limitative, and an integral water treatment apparatus may be constructed, for example, by accommodating the filtration apparatus 10 and the reverse osmosis membrane apparatus 31 in a hollow container 32, as shown in FIG. 6. By using the integral water treatment apparatus, compactness is achieved, and the number of components can be decreased. A single filtration apparatus 10 and a single reverse osmosis membrane apparatus 31 may be provided, or a plurality of the filtration apparatuses 10 and a plurality of the reverse osmosis membrane apparatuses 31 may be provided.

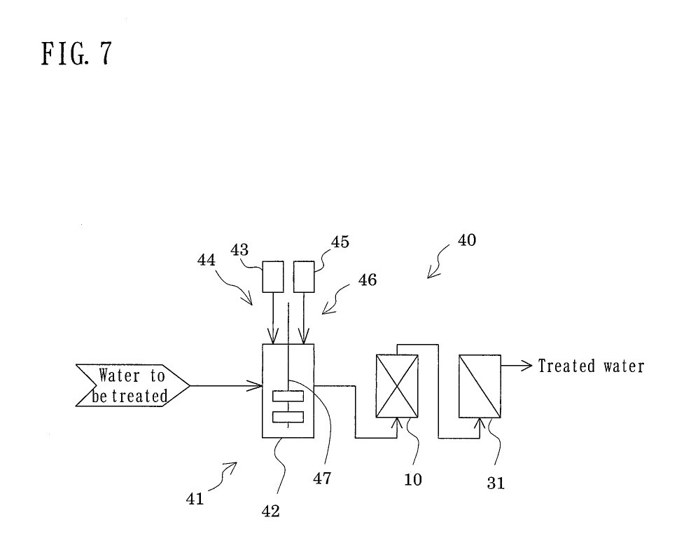

Alternatively, a flocculation means 41 may be provided in a stage preceding the filtration apparatus 10 to construct a water treatment apparatus 40. The water treatment apparatus 40, as shown in FIG. 7, has a flocculation means 41 comprising a reaction tank 42 into which water to be treated (raw water) is introduced, a chemical introduction means 44 composed of a pump or the like for introducing a chemical, such as a polymer flocculant, into the reaction tank 42 from a chemical tank 43 holding the chemical, and an inorganic flocculant introduction means 46 composed of a pump or the like for introducing an inorganic flocculant into the reaction tank 42 from an inorganic flocculant tank 45 holding the inorganic flocculant; and has in a stage succeeding the flocculation means 41 the filtration apparatus 10 of Embodiment 1 into which the water subjected to flocculation, such as adsorption or coagulation, in the reaction tank 42 is introduced. The water treatment apparatus 40 is further provided with a reverse osmosis membrane apparatus 31 in a stage succeeding the filtration apparatus 10. The reverse osmosis membrane apparatus 31 is the same as that in the aforementioned water treatment apparatus 30, and performs membrane separation of the water to be treated with the use of a reverse osmosis membrane.

With such a water treatment apparatus 40, the water to be treated (raw water) is introduced into the reaction tank 42 as the first step. Then, the chemical held in the chemical tank 43, such as a polymer flocculant, and the inorganic flocculant held in the inorganic flocculant tank 45 are introduced by the chemical introduction means 44 and the inorganic flocculant introduction means 46 into the reaction tank 42, where they are added to the water to be treated. The water to be treated, which has the polymer flocculant and the inorganic flocculant added thereto, is stirred with a stirrer 47 for flocculation. Then, the flocculated water to be treated is discharged from the reaction tank 42, and sent to the filtration apparatus 10. The water to be treated, which has been introduced into the filtration apparatus 10, crosses the mesh sheet 5 longitudinally, whereby suspended matter contained in the water to be treated is removed. Clear treated water discharged from the filtration apparatus 10 is supplied to the reverse osmosis membrane apparatus 31 located in the succeeding stage, where it is subjected to membrane separation by the reverse osmosis membrane. The water treatment apparatus may be free from the reverse osmosis membrane apparatus 31.

Examples of the water to be treated are water containing humic acid-based or fulvic acid-based organic substances, water containing biological metabolites such as sugars produced by algae, etc., and water containing synthetic chemical substances such as surface active agents. Concrete examples are industrial water, city water, well water, river water, lake water, and industrial waste water (particularly, bioremediation water resulting after bioremediation of waste water from factories). However, they are not limitative. Humus refers to humic substances occurring upon degradation of plants, etc. by microorganisms, and includes humic acid and so on. Water containing humus has humus and/or humus-derived soluble COD components, suspended matter, or chromatic components.

Examples of the polymer flocculant added as the flocculant to the water to be treated are anionic organic polymer flocculants such as poly(meth)acrylic acid, copolymer of (meth)acrylic acid and (meth)acrylamide, and their alkali metal salts; nonionic organic polymer flocculants such as poly(meth)acrylamide; cationic organic polymer flocculants such as homopolymers comprising cationic monomers, for example, dimethylaminoethyl (meth)acrylate or quaternary ammonium salts thereof, and dimethylaminopropyl (meth) acrylamide or quaternary ammonium salts thereof, and copolymers of these cationic monomers and nonionic monomers copolymerizable therewith; and amphoteric organic polymer flocculants which are copolymers of the above anionic monomers, cationic monomers and nonionic monomers copolymerizable with these monomers. There are no limitations on the amount of the polymer flocculant added. Its amount may be adjusted depending on the properties of the water to be treated, and is generally 0.01 to 10 mg/L as a solid content with respect to the water to be treated.

The inorganic flocculant added to the water to be treated is not restricted, and its examples are aluminum salts such as aluminum sulfate and polyaluminum chloride, and iron salts such as ferric chloride and ferrous sulfate. The amount of the inorganic flocculant added is not restricted, either. Its amount may be adjusted depending on the properties of the water to be treated, and is generally 0.5 to 10 mg/L, in terms of aluminum or iron, with respect to the water to be treated. If polyaluminum chloride (PAC) is used as the inorganic flocculant, optimum flocculation is achieved, when the pH of the water to be treated, which has the polymer flocculant and the inorganic flocculant added thereto, is set at a value of the order of 5.0 to 7.0, although flocculation depends on the properties of the water to be treated. The inorganic flocculant may be added before or after the addition of the polymer flocculant to the water to be treated, or may be added simultaneously with the addition of the polymer flocculant.

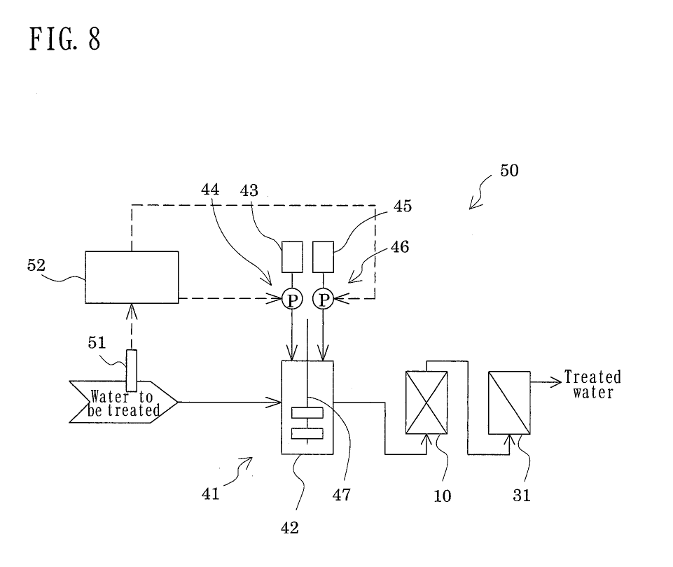

In addition to the water treatment apparatus 30 or the water treatment apparatus 40, an absorbance measuring means 51 for measuring the absorbance of the water to be treated may be provided in a raw water tank where the water to be treated (raw water) is stored, as shown in FIG. 8. Further, an addition amount control means 52 may be provided which receives data on the absorbance measured with this absorbance measuring means 51, calculates the amount of addition of the polymer flocculant introduced from the chemical tank 43 into the reaction tank 42 and the amount of addition of the inorganic flocculant introduced from the inorganic flocculant tank 45 into the reaction tank 42, and controls these amounts of addition. In this manner, a water treatment apparatus 50 may be constructed.

The addition amount control means 52 has, as addition amount correction information, an equation of the relation between the absorbance of the water to be treated and the optimum amount of the polymer flocculant added, the equation having been obtained by treating the water to be treated, which has different water qualities and various absorbances, in a jar tester using the polymer flocculant. Based on the absorbance data on the water to be treated (raw water) from the absorbance measuring means 51 and this relational equation (addition amount correction information), the addition amount control means 52 calculates the optimum amount of addition, and controls the amount of addition of the polymer flocculant introduced from the chemical introduction means 44. Similarly, the addition amount control means 52 has, as addition amount correction information, an equation of the relation between the absorbance of the water to be treated and the optimum amount of the inorganic flocculant added, the equation having been obtained by treating the water to be treated, which has different water qualities and various absorbances, with the use of the inorganic flocculant. Based on the absorbance data on the water to be treated (raw water) from the absorbance measuring means 51 and this relational equation (addition amount correction information), the addition amount control means 52 calculates the optimum amount of addition, and controls the amount of addition of the inorganic flocculant introduced from the inorganic flocculant introduction means 46.

A detailed explanation will be offered, with the polymer flocculant taken as an example. First, the relation between the absorbance of the water to be treated and the amount of addition of the polymer flocculant suitable for treating the water to be treated which has this absorbance, namely, the amount of addition sufficient to flocculate soluble organic matter as suspended matter, but not to be an excess, is obtained beforehand as addition amount control information. Then, at the time of water treatment, the absorbance of the water to be treated is measured, and the amount of addition of the polymer flocculant is controlled based on the results of measurement of the absorbance and the addition amount correction information.

In connection with the water to be treated, there is a correlation, expressed by the following equation, between the concentration of the soluble organic matter and the absorbances obtained by measurements of one or more wavelengths in the ultraviolet region with wavelengths of 200 nm to 400 nm as well as in the visible region with wavelengths of 500 nm to 700 nm:

Soluble organic matter concentration=A×[ultraviolet region absorbance−visible region absorbance] [Equation 1]

The soluble organic matter concentration also has a correlation with the optimum amount of addition of the polymer flocculant judged from the time required for filtering a constant amount of sample water with the use of a 0.45 μm membrane filter (i.e., KMF value). By measuring the absorbances in each of the ultraviolet region and the visible region for one or more wavelengths, therefore, the optimum amount of the polymer flocculant added can be estimated.

Concretely, jar tests are conducted beforehand on the water to be treated which has different water qualities, for example, the water to be treated, such as industrial water sampled on different days, to obtain a relational equation of the difference between the absorbance in the ultraviolet region and the absorbance in the visible region versus the optimum concentration of the polymer flocculant added (i.e., addition amount control information), as shown in Equation (I) below. In the Equation (I), A to C represent constants dependent on water quality, such as the concentration of soluble organic matter in the water to be treated; E260 represents the absorbance at a wavelength of 260 nm; and E660 represents the absorbance at a wavelength of 660 nm. At the time of water treatment, the absorbance of the water to be treated is measured, the optimum amount of addition of the polymer flocculant is found based on the results of measurement of the absorbance and from the following Equation (I), and the polymer flocculant in the optimum amount of addition is added to the water to be treated.

Concentration of polymer flocculant added=A×(E260−E660)^{B}+C(I) [Equation 2]

In the above example, the relational equation of the difference between the absorbance in the ultraviolet region and the absorbance in the visible region versus the optimum concentration of the polymer flocculant added is shown as the addition amount control information. However, this is not limitative, and the addition amount control information may be based on threshold control, for example. The threshold control is exemplified by a mode in which when the absorbance difference is less than a predetermined value a₁, the concentration of the polymer flocculant added is set at b₁; when the absorbance difference is the predetermined value a₁ to a₂, the concentration of the polymer flocculant added is set at b₂; and when the absorbance difference exceeds the predetermined value a₂, the concentration of the polymer flocculant added is set at b₃. However, this is not limitative.

As described above, the amount of the polymer flocculant added is controlled based on the amount of the soluble organic matter serving as the suspended matter contained in the water to be treated, whereby the polymer flocculant in the optimum amount can be added to the water to be treated. Thus, the water to be treated can be treated efficiently. Even if the water quality of the water to be treated changes, the polymer flocculant is added in the optimum amount in accordance with the water quality of the water to be treated after changing, so that treated water with high clarity can be obtained stably. Control over the amount of addition of the inorganic flocculant may be exercised in the same manner as is the above-mentioned control over the amount of addition of the polymer flocculant.

A correlation also exists between the turbidity of the water to be treated and the concentration of the soluble organic matter. Thus, it is permissible to measure the turbidity instead of the absorbance, and exercise control in the same manner as for the absorbance. By this procedure, the polymer flocculant or the inorganic flocculant in the optimum amount can be added to the water to be treated. Hence, the water to be treated can be treated efficiently. Even if the water quality of the water to be treated changes, the polymer flocculant or the inorganic flocculant is added in the optimum amount in accordance with the changed water quality of the water to be treated, so that treated water with high clarity can be obtained stably. It is also acceptable to perform both of control over the amount of addition of the flocculant in accordance with the absorbance data on the water to be treated (raw water) and control over the amount of addition of the flocculant in accordance with the turbidity data on the water to be treated.

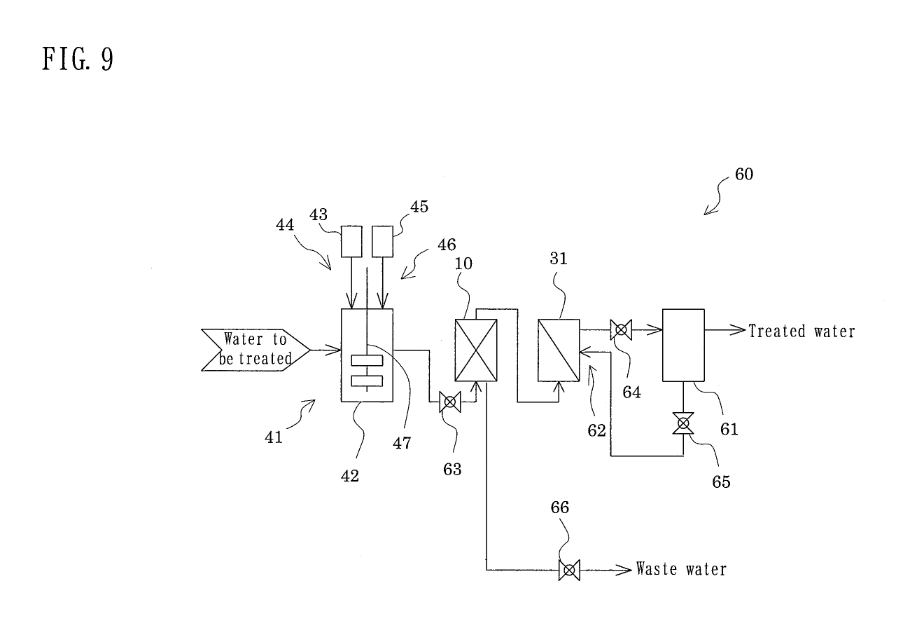

In addition to the water treatment apparatus 30 and the water treatment apparatus 40, moreover, there may be provided a cleaning fluid introduction means, which introduces a cleaning fluid or a mixture of a cleaning fluid and air into the water treatment apparatus from a direction opposite to the direction of water passage of the water to be treated, to construct a water treatment apparatus. Concretely, the water treatment apparatus, as shown, for example, in FIG. 9, has a treated water tank 61 for storing the water to be treated which has been treated by the reverse osmosis membrane apparatus 31, and has a cleaning fluid introduction means 62 for introducing the water to be treated (cleaning fluid), which is stored in the treated water tank 61, or a mixture of the water to be treated and air (i.e., cleaning fluid) into the reverse osmosis membrane apparatus 31 and the filtration apparatus 10.

With the water treatment apparatus 60 of the above configuration, the water to be treated, which has been subjected to filtration and then to membrane separation, is stored in the treated water tank 61. The filter 2, etc. of the filtration apparatus 10 gradually deteriorates in performance owing to the deposition of contaminants, such as solids which are ascribed to the polymer flocculant or the inorganic flocculant added as the flocculant or other suspended matter, upon water passage of the water to be treated. The separation membrane, such as the reverse osmosis membrane, of the reverse osmosis membrane apparatus 31 gradually deteriorates in membrane separation performance owing to the deposition of contaminants, such as solids which are ascribed to the polymer flocculant or the inorganic flocculant added as the flocculant or other suspended matter, upon membrane separation. Thus, a valve 63 provided between the reaction tank 42 and the filtration apparatus 10, and a valve 64 provided between the reverse osmosis membrane apparatus 31, etc. and the treated water tank 61 and opened during membrane separation are closed with an arbitrary frequency to interrupt membrane separation. On the other hand, another valve 65 connecting the treated water tank 61 and the reverse osmosis membrane apparatus 31 is opened to flow the water to be treated which is stored in the treated water tank 61, or a liquid as a mixture of this water and air, through the reverse osmosis membrane apparatus 31 for a time, say, of the order of 1 minute in a direction opposite to the direction during treatment, by means of the cleaning fluid introduction means 62 such as a pump, thereby flushing the separation membrane with the cleaning fluid or air. Then, the cleaning fluid or air flowing through the reverse osmosis membrane apparatus 31 passes through the filtration apparatus 10, thereby backwashing the filter body 4, etc. with the cleaning fluid or air. Then, the cleaning fluid is discharged as waste water from the filtration apparatus 10 to the outside of the water treatment apparatus 60 via a valve 66. Even if a pump or the like for feeding the cleaning fluid is not present between the reverse osmosis membrane apparatus 31 and the filtration apparatus 10, the cleaning fluid can be introduced into the filtration apparatus 10 by the cleaning fluid introduction means 62 which introduces the cleaning fluid into the reverse osmosis membrane apparatus 31.

After the cleaning of the reverse osmosis membrane apparatus 31 and the filtration apparatus 10 with the cleaning fluid or air is completed, the valve 63 and the valve 64 are opened again, and the valve 65 and the valve 66 are closed, to resume filtration and membrane separation. By so cleaning the filtration apparatus 10 and the membrane separation means such as the reverse osmosis membrane apparatus 31, the suspended matter adsorbed to the filter 2 and the separation membrane can be removed. Thus, deterioration in the filtration performance or the membrane separation performance can be suppressed reliably. The water to be treated or air may be introduced only into the filtration apparatus 10.

In the present embodiment, the polymer flocculant and the inorganic flocculant are used as the flocculant, but only one of them may be used. In the present embodiment, moreover, the flocculant is introduced into the reaction tank 42, but may be introduced in the stage preceding the reaction tank 42.

The water treatment apparatus may be further provided with means for purification of the water to be treated, such as decarboxylation or activated carbon treatment. If desired, the water treatment apparatus may be equipped with ultraviolet irradiation means, ozone treatment means, bioremediation means, etc.

If desired, moreover, a coagulant, a microbicide, a deodorizer, an anti-foaming agent, an anti-corrosive, etc. may be added and, for example, can be added by mixing the respective additives into the chemical tank 43.

### Embodiment 3

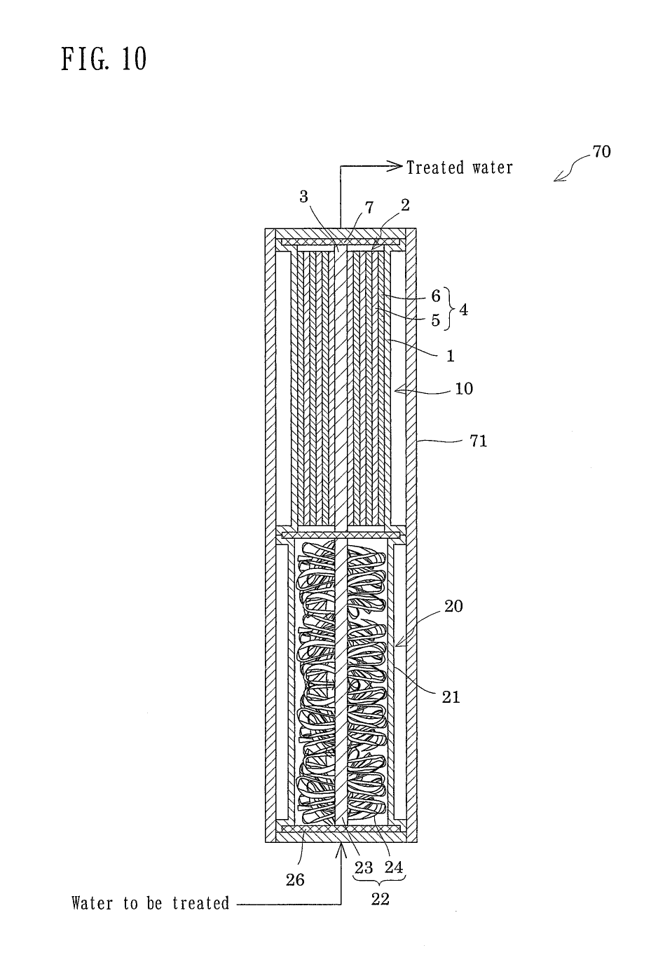

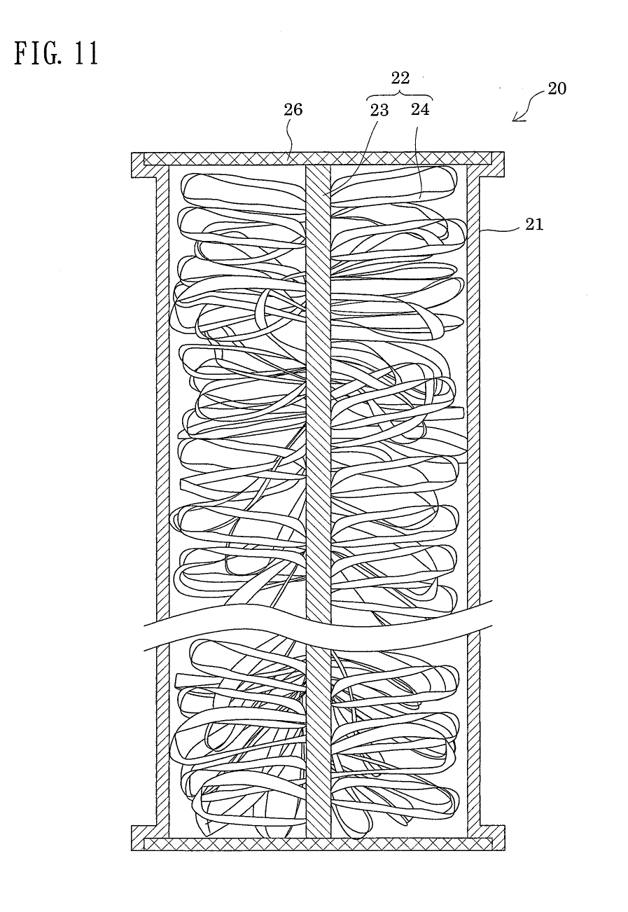

FIG. 10 is a longitudinal sectional view showing the configuration of a water treatment apparatus 70 according to Embodiment 3 of the present invention. FIG. 11 is a sectional view showing the configuration of a macrofiltration apparatus 20. The same members as those in Embodiment 1 and Embodiment 2 are assigned the same numerals as in these embodiments, and duplicate explanations are omitted.

As shown in FIG. 10, the water treatment apparatus 70 has the macrofiltration apparatus 20 and the filtration apparatus 10 of Embodiment 1 accommodated in a water treatment vessel 71 in which they are arranged longitudinally in this sequence from the upstream side.

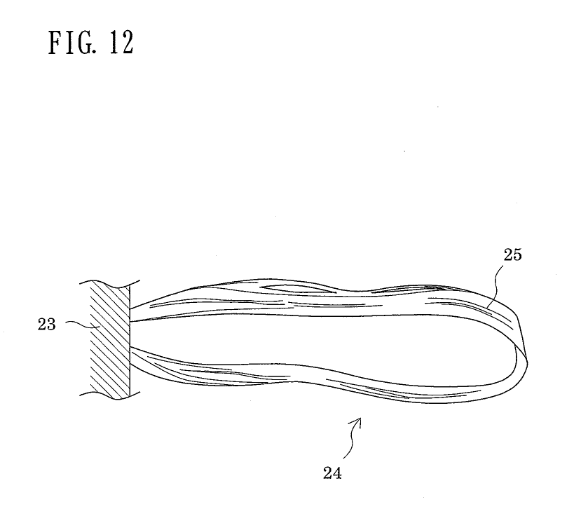

As shown in FIG. 11, the macrofiltration apparatus 20 has a tubular macrofiltration tank 21 through which water to be treated is passed, and a macro-filter 22 for trapping suspended matter contained in the water to be treated which is being passed. The macro-filter 22 comprises a core material 23 connected to both ends in the direction of water passage of the macrofiltration tank 21, and strip-shaped suspended matter trapping portions 24. Circular plates 26 of resin or the like having a plurality of holes enough for the free passage of water to be treated, which contains the suspended matter, are provided at both ends in the direction of water passage of the macrofiltration tank 21, and both ends of the core material 23 are fixed to the center of each plate 26. The suspended matter trapping portions 24 are partly woven into and fixed to the core material 23, and have so-called looped parts which are unfixed and which are provided so as to spread radially toward the inner wall surface of the macrofiltration tank 21. In this manner, the macro-filter 22 spreads throughout the macrofiltration tank 21. Thus, the suspended matter trapping portions 24 intersect the direction of water passage, so that the suspended matter contained in the water to be treated can be trapped by the suspended matter trapping portions 24. The string-shaped suspended matter trapping portion 24 is a long rectangular portion (tape) in the form of a loop, and is provided with a plurality of slits 25 which do not reach the end in the longitudinal direction, as shown in an enlarged view of the string-shaped suspended matter trapping portion 24 as FIG. 12. By providing the slits 25 in such a manner, the effect of trapping the suspended matter is enhanced.

The macro-filter 22 is charged into the macrofiltration tank 21 such that the void content of a filtration portion when passed through by the water to be treated is 50 to 95%, preferably 60 to 90%. The void content is a value obtained from the equation indicated below. The filtration portion refers to a region where the suspended matter in the water to be treated is trapped by the macro-filter 22, namely, a region remaining after excluding a part, which does not contribute to filtration (the part corresponding to the core material 23 in the present embodiment), from a layer whose side surface is the inner wall surface of the macrofiltration tank 21, whose opposite ends in the thickness direction are both ends in the direction of water passage of the macro-filter 22 during water passage, and which is filled with the suspended matter trapping portions 24 of the macro-filter 22. If the part not contributing to filtration is absent, the filtration portion refers to the layer whose side surface is the inner wall surface of the macrofiltration tank 21, whose opposite ends in the thickness direction are both ends in the direction of water passage of the macro-filter 22 during water passage, and which is filled with the suspended matter trapping portions 24 of the macro-filter 22. The “volume of filtration portion−volume of suspended matter trapping portions”, in an example such as the present embodiment in which the macro-filter 22 is not compacted, but remains charged into the macrofiltration tank 21, during filtration operation (during water passage of the water to be treated) to form the filtration portion at the time of filtration operation, can be easily determined by subtracting the volume of the core material 23 from the amount of the water to be treated which has overflowed when the macro-filter 22 is placed in the macrofiltration tank 21 filled with the water to be treated. In the present embodiment, both ends of the macro-filter 22 are fixed to both ends in the direction of water passage of the macrofiltration tank 21, and the macro-filter 22 spreads over the entire macrofiltration tank 21 during water passage of the water to be treated. Hence, the region remaining after subtracting the part corresponding to the core material 23 from the entire interior of the macrofiltration tank 21 is the filtration portion.

Void content(%)=[(volume of filtration portion−volume of suspended matter trapping portions)/volume of filtration portion]×100 [Equation 3]

When the water to be treated is passed through the macrofiltration apparatus 20 of the above-described configuration, the water to be treated passes through the respective string-shaped suspended matter trapping portions 24 and the slits 25 provided in the suspended matter trapping portions 24. During this course, the suspended matter contained in the water to be treated is trapped by the string-shaped suspended matter trapping portions 24 and the slits 25, and the water to be treated which has been deprived of the suspended matter is discharged from the macrofiltration tank 21. Since the macro-filter 22 is charged such that the void content of the filtration portion during water passage is 50 to 95%, water pas sage is not impeded, and the trapping of the suspended matter is satisfactory.

As described above, water passage is not impeded, and the trapping of the suspended matter is rendered satisfactory, by charging the macro-filter 22 such that the void content of the filtration portion during water passage is 50 to 95%. Thus, the effect is exhibited that the water to be treated which has been treated by the macrofiltration apparatus 20 is clear (for example, turbidity of the order of 3 or less). Moreover, clogging of the macrofiltration apparatus 20 itself, the filtration apparatus 10 provided in the subsequent stage, or the reverse osmosis membrane apparatus 31 provided if necessary can be suppressed. If the void content is higher than 95%, water passage becomes satisfactory and fast filtration is easily achieved, but the turbidity of treated water is markedly high. If the void content is lower than 50%, the trapping of the suspended matter is satisfactory, but water passage is so insufficient that clogging may occur in the macrofiltration apparatus 20, the filtration apparatus 10 provided in the subsequent stage, or the reverse osmosis membrane apparatus 31, whereupon the rate of increase in the differential pressure becomes markedly high. Particularly when the filtration operation is performed at a high speed of, say, 100 m/h or above, or when the water to be treated which has a high turbidity (e.g., 20 degrees or higher) is treated, the problem tends to occur that suspended matter in the resulting treated water worsens, or that the apparatus clogs. By using the macrofiltration apparatus 20 charged with the macro-filter 22 such that the void content is 50 to 95%, on the other hand, clogging can be suppressed, and clear treated water is obtained, even in the case of the high speed operation or the highly turbid water to be treated. Even when low speed treatment is carried out or the low turbidity water to be treated is treated, it goes without saying that clogging can be suppressed, and clear treated water is obtained. Since the void content is preferably uniform, it is preferred that the suspended matter trapping portions 24 be charged up to sites near both ends in the water passage direction of the macrofiltration tank 21. It is also preferred that the suspended matter trapping portions 24 be charged up to sites near the inner wall surface of the macrofiltration tank 21.

The volume of the filtration portion preferably does not change between states, namely, between the time of water passage of the water to be treated and other state such as the time of backwash to be described later or the time of stoppage of filtration. The change rate of the volume of the filtration portion is preferably 30% or less, more preferably 10% or less. By setting such a range, the macrofiltration apparatus can be rendered compact.

In the present embodiment, the size of the macrofiltration tank 21, if tubular in shape, can be made to have a diameter of 100 to 1,000 mm and a height of 200 to 1,000 mm. If the size of the macrofiltration tank 21 is larger than the size of the macro-filter 22, it is permissible, for example, to charge a plurality of the macro-filters 22 into the macrofiltration tank 21, or upsize the suspended matter trapping portions 24 of the macro-filter 22, thereby adjusting the void content of the filtration portion during water passage to 50 to 95%.

Examples of the material for the core material 23 or the suspended matter trapping portion 24 are synthetic resins such as polypropylene, polyester and nylon. The core material 23 may be given strength by knitting up synthetic fibers, such as polypropylene, polyester or nylon, during the manufacturing process. Alternatively, like a twisted brush, an example may be adopted in which a wire formed from SUS or a resin-coated metal free from corrosion is used as the core material 23, the suspended matter trapping portions 24 are arranged uniformly, and then the metal is twisted to construct the macro-filter 22 having the suspended matter trapping portions 24 spread radially. By so enhancing the strength of the core material 23, the core material 23 does not bend any more, and the ends of the macro-filter 22 are easily fixed thereto. Thus, replacement work for the macro-filter 22 is facilitated.

The sizes of the core material 23 and the suspended matter trapping portion 24 are not restricted, except that these components are arranged such that the void content is set at a value within the aforementioned range. For example, the size can be such that the thickness is 0.05 to 2 mm, the width is 1 to 50 mm, and the length (the distance from the core material when the water to be treated is passed) is of the order of 10 to 500 mm, preferably, the thickness is 0.3 to 2 mm, the width is 1 to 20 mm, and the length is of the order of 50 to 200 mm.

In the above-described example, the tubular macrofiltration tank 21 is shown. However, the tubular shape is not limitative; a shape which allows water passage, namely, a hollow shape, is acceptable, and a prismatic shape having a hollow inside, for example, may be adopted. In the above example, moreover, both ends of the core material 23 are fixed to the plates 26. However, this is not limitative and, for example, only one end of the core material may be fixed to the plate.

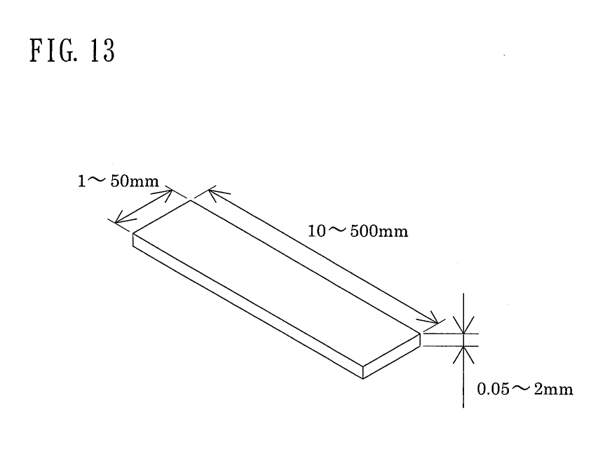

In the above-described example, the loop-shaped suspended matter trapping portions 24 protrude from the core material 23, but this is not limitative. For example, a plurality of strip-shaped suspended matter trapping portions may be used, as shown in FIG. 13, and one end of each suspended matter trapping portion may be fixed to the core material. In the present embodiment, the cross-sectional shape of the suspended matter trapping portion 24 is quadrilateral, but there are no limitations in this connection, and a circular shape, for example, may be adopted. The length of each suspended matter trapping portion may be the same or different. In the aforementioned embodiment, moreover, the material for the suspended matter trapping portion 24 is of a single type, but two types or more may be used. Furthermore, there may be a plurality of the slits or the single slit provided in the suspended matter trapping portion, or the slits need not be provided. The core material 23 may be absent, and the macro-filter 22 may be composed of the suspended matter trapping portions only. Since it is preferred that the macro-filter 22 be present nearly uniformly in the macrofiltration tank 21, however, the suspended matter trapping portions are preferably fixed at a predetermined position in the filtration tank.

FIG. 10 shows the example in which the filtration apparatus 10 and the macrofiltration apparatus 20 are integrated. However, these apparatuses may be provided individually, and connected together by piping or the like. The above example illustrates the water treatment apparatus 70 having the macrofiltration apparatus 20 provided in the stage preceding the filtration apparatus 10. However, in addition to the water treatment apparatus 30, the water treatment apparatus 40, the water treatment apparatus 50 or the water treatment apparatus 60 of Embodiment 2, the macrofiltration apparatus 20 may be provided in the stage preceding each filtration apparatus 10 to construct a water treatment apparatus.

### EXAMPLES

The present invention will now be described in further detail based on Examples and Comparative Example, but is in no way limited by these examples.

### Example 1

As water to be treated (raw water), industrial water having turbidity of 2.0 to 3.0 degrees, a residual chlorine content (as Cl₂) of less than 0.05 ppm, and a water temperature of 24.5 to 25.5° C. was passed for treatment in an amount fulfilling the following conditions by use of the water treatment apparatus shown in FIG. 5: the inlet pressure of the reverse osmosis membrane apparatus: 0.75 MPa, the amount of concentrated water discharged from the reverse osmosis membrane apparatus: 1.35 m³/h, and the amount of treated water: 0.25 m³/h. The configurations of the filtration apparatus 10 and the reverse osmosis membrane apparatus 31 are as follows:

<Filtration Apparatus>

Filtration tank . . . A cylindrical vessel (vessel) with an internal diameter of 100 mm.

Filter . . . A mesh sheet was a woven fabric which was formed from warp threads and weft threads composed of polyethylene fibers having a diameter of 0.3 mm, and which measured 1 m×10 m and had an intersection height T of 0.85 mm, an opening of 3,000 jam, and an opening area of 82%, as shown in FIGS. 4(a), 4(b). A spacer was a PET (polyethylene terephthalate) film (water-impermeable sheet) measuring 1 m×10 m and 0.1 mm thick. The mesh sheet and the spacer were superposed and thermally fused at four corners to prepare a sheet member. This sheet member was wound by a length of 10 m round a polyvinyl chloride pipe (core material) having a diameter of 20 mm such that the water-impermeable film was located externally to form a filter with a diameter of 100 mm.

Water-impermeable member: The gap between the inner wall of the filtration tank and the outer periphery of the filter body, and the gap in the vicinity of the core material were charged with an adhesive allowing no passage of the water to be treated.

Amount of water passage through the filtration apparatus: 1.6 m³/h (LV=200 m/h)

<Reverse Osmosis Membrane Apparatus>

Reverse osmosis membrane . . . A spiral type one (diameter 100 mm) using FILMTEC LE-4040 produced by The Dow Chemical Co. (height of the intersection of the raw water flow path spacer: 0.85 mm)

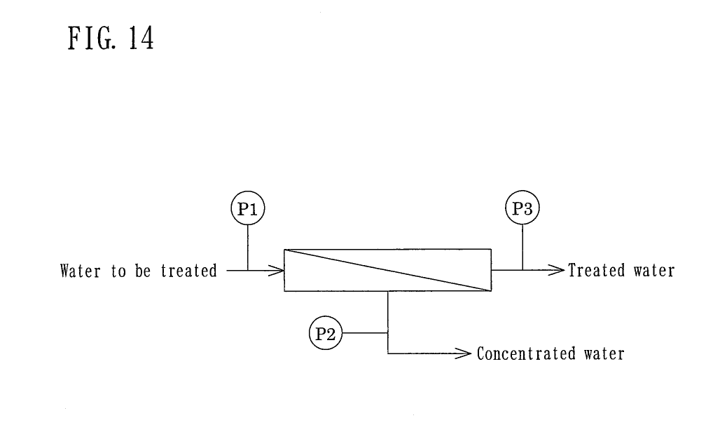

The differential pressure of the reverse osmosis membrane during treatment was found as the difference between the pressure P1 at the inlet of the reverse osmosis membrane apparatus and the pressure P2 at the concentrated water outlet thereof (P1−P2 (MPa)), as shown in FIG. 14. Even after 72 hours of water passage, the differential pressure was nearly constant and stable, thus confirming that clogging was prevented. Then, the differential pressure rose to 0.2 MPa, and water passage became impossible.

In connection with the water to be treated (raw water) which was introduced into the filtration apparatus 10, and treated water discharged from the reverse osmosis membrane apparatus 31 at 72 hours after the start of water passage of the water to be treated, the number of fine particles was measured with a particulate counter in the laser light shutoff mode, and the turbidity was determined by a transmitted light measuring method using a kaolin standard solution. The results are shown in Table 1. As shown in Table 1, suspended matter measuring 200 μm or more was removed in Example 1, indicating that the suspended matter was markedly removed as compared with Comparative Example 1 not using the filtration apparatus 10. In Example 1, therefore, it was confirmed that treated water discharged from the filtration apparatus 10 was clear and, as a result, membrane separation by the reverse osmosis membrane apparatus 31 in the subsequent stage was performed preferably.

TABLE 1

| | Number of | | | | | | |
|---|---|---|---|---|---|---|---|
| | fine | | | | | | |
| Diameter of | particles | Number of fine particles in treated water discharged from | | | | | |
| fine | in raw | reverse osmosis membrane apparatus (No./mL) | | | | | |
| particles | water | | | | | | Comp. |
| (μm) | (No./mL) | Ex. 1 | Ex. 2 | Ex. 3 | Ex. 4 | Ex. 5 | Ex. 1 |
| 1 < ≦50 | 1.5 × 10⁴ | 1.0 × 10⁴ | 500 | 750 | 450 | 520 | 1.4 × 10⁴ |
| 50 < ≦100 | 1.2 × 10⁴ | 5.0 × 10³ | 10 | 15 | 12 | 15 | 1.0 × 10⁴ |
| 100 < ≦200 | 3200 | 30 | ND | ND | ND | ND | 800 |
| 200 < ≦300 | 800 | 3 | ND | ND | ND | ND | 10 |
| 400 < ≦500 | 500 | 1 | ND | ND | ND | ND | 5 |
| 500< | ND | ND | ND | ND | ND | ND | ND |
| Turbidity | 2.5 | Less | Less | Less | Less | Less | Less |
| | | than 1.0 | than 1.0 | than 1.0 | than 1.0 | than 1.0 | than 1.0 |

ND: Not detected.

### Comparative Example 1

The same procedure as in Example 1 was performed, except that the filtration apparatus 10 was not provided, and only the reverse osmosis membrane apparatus was used. The results of measurements of the number of fine particles and the turbidity are shown in Table 1. The differential pressure of the reverse osmosis membrane rose, beginning immediately after water pas sage, and reached 0.2 MPa in 24 hours, making water passage impossible.

### Example 2

The same procedure as in Example 1 was performed, except that a nonwoven fabric formed from polyolefin fibers with a diameter of 17.5 μm and measuring 1 m×10 m×0.22 mm in thickness (FT-330N, produced by Japan Vilene Company, Ltd.), and a film formed from PET (polyethylene terephthalate) and measuring 1 m×10 m×0.1 mm in thickness (water-impermeable film) were superposed and thermally fused at four corners, and the resulting composite was fixed and used as the spacer. The results of measurements of the number of fine particles and the turbidity are shown in Table 1. Even after 30 days of water passage, the differential pressure of the reverse osmosis membrane was nearly constant and stable, thus confirming that clogging was prevented for a long period of time. As shown in Table 1, suspended matter measuring 50 μm or more was removed in Example 2, indicating that the suspended matter was markedly removed as compared with Comparative Example 1 not using the filtration apparatus 10 and even in comparison with Example 1. In Example 2, therefore, it was confirmed that treated water discharged from the filtration apparatus 10 was clear and, as a result, membrane separation by the reverse osmosis membrane apparatus 31 in the subsequent stage was performed preferably.

### Example 3

The same procedure as in Example 1 was performed, except that a nonwoven fabric formed from activated carbon fibers with a diameter of 15 μm and measuring 1 m×10 m×0.3 mm in thickness (activated carbon fibers A-15, produced by UNITIKA, LTD.), and a film formed from PET (polyethylene terephthalate) and measuring 1 m×10 m×0.1 mm in thickness (water-impermeable film) were superposed and thermally fused at four corners, and the resulting composite was fixed and used as the spacer. The results of measurements of the number of fine particles and the turbidity are shown in Table 1. Even after 30 days of water passage, the differential pressure of the reverse osmosis membrane was nearly constant and stable, thus confirming that clogging was prevented for a long period of time. As shown in Table 1, suspended matter measuring 50 μm or more was removed in Example 3, indicating that the suspended matter was markedly removed as compared with Comparative Example 1 and even in comparison with Example 1. In Example 3, therefore, it was confirmed that treated water discharged from the filtration apparatus 10 was clear and, as a result, membrane separation by the reverse osmosis membrane apparatus 31 in the subsequent stage was performed preferably.

Tap water of Nogi-machi, Tochigi Prefecture, Japan which had a residual chlorine content of 0.5 ppm (as Cl₂) was passed for 100 hours through the same water treatment apparatus as in Example 3. Treated water having a residual water concentration of less than 0.05 ppm (as Cl₂) was obtained stably.

### Example 4

As water to be treated (raw water), industrial water having turbidity of 8.0 to 10 degrees, a residual chlorine content (as Cl₂) of less than 0.05 ppm, and a water temperature of 24.5 to 25.5° C. was passed for treatment in an amount fulfilling the following conditions by use of a water treatment apparatus having the macrofiltration apparatus 20 provided directly before the water treatment apparatus 40 shown in FIG. 7, concretely, a water treatment apparatus having the flocculation means 41, the macrofiltration apparatus 20, the filtration apparatus 10, and the reverse osmosis membrane apparatus 31 provided in this sequence from the upstream side: the inlet pressure of the reverse osmosis membrane apparatus: 0.75 MPa, the amount of concentrated water discharged from the reverse osmosis membrane apparatus: 1.35 m³/h, and the amount of treated water: 0.25 m³/h. The configurations of the flocculation means 41, the macrofiltration apparatus 20, the filtration apparatus 10, and the reverse osmosis membrane apparatus 31 are as follows:

<Flocculation Means>

Flocculant . . . Polyaluminum chloride (PAC: 10% by weight, as Al₂O₃) in an amount of 30 mg/L with respect to water to be treated, and Kurifix CP604 (Kurita Water Industries Ltd.) as a cationic polymer flocculant in an amount of 1.0 ppm with respect to the water to be treated were added to the water to be treated.

<Macrofiltration Apparatus>

As shown in FIG. 11, the macrofiltration apparatus comprised the core material 23 and the string-shaped suspended matter trapping portions 24, and both ends of these components were fixed to the plates 26 disposed at both ends in the water passage direction of the macrofiltration tank 21. The core material 23 had a volume of 250 mL, and each suspended matter trapping portion 14 was woven in a loop form into the core material such that its thickness was 0.5 mm, its width was 2 mm, and its length (distance of its loop end from the core material when the water to be treated was passed) was 100 mm. The void content of the filtration portion (the remainder after subtracting the volume of the core material 23 from the volume of the interior of the macrofiltration tank 21) during water passage was 85%. Since the core material was fixed at both ends, the change in the volume of the filtration portion was nearly 0% when the volume during passage of the water to be treated and the volume on other occasion were compared. The size of the macrofiltration tank 21 was such that its diameter was 200 mm and its height was 500 mm.

Amount of water passage through the macrofiltration apparatus: 1.6 m³/h (LV=200 m/h)

<Filtration Apparatus>

Filtration tank . . . A cylindrical vessel (vessel) with an internal diameter of 100 mm.

Filter . . . A mesh sheet was a woven fabric which was formed from warp threads and weft threads composed of polyethylene fibers having a diameter of 0.3 mm, and which measured 1 m×10 m and had an intersection height T of 0.85 mm, an opening of 3,000 μm, and an opening area of 82%, as shown in FIGS. 4(a), 4(b). A spacer consisted of a nonwoven fabric (FT-330N, produced by Japan Vilene Company, Ltd.) formed from polyolefin fibers having a diameter of 17.5 jam and measuring 1 m×10 m×0.22 mm in thickness, and a PET (polyethylene terephthalate) film (water-impermeable film) measuring 1 m×10 m×0.1 mm thick, the nonwoven fabric and the film being superposed and thermally fused at four corners. The mesh sheet and the spacer were superposed and thermally fused at four corners to prepare a sheet-shaped member. This sheet member was wound by a length of 10 m round a polyvinyl chloride pipe (core material) having a diameter of 20 mm such that the water-impermeable film was located externally to form a filter with a diameter of 100 mm.

Water-impermeable member: The gap between the inner wall of the filtration tank and the outer periphery of the filter body, and the gap in the vicinity of the core material were charged with an adhesive allowing no passage of the water to be treated.

Amount of water passage through the filtration apparatus: 1.6 m³/h (LV=200 m/h)

<Reverse Osmosis Membrane Apparatus>

Reverse osmosis membrane . . . A spiral type one (diameter 100 mm) using FILMTEC LE-4040 produced by The Dow Chemical Co. (height of the intersection of the raw water flow path spacer: 0.85 mm)

The differential pressure of the reverse osmosis membrane during treatment was found as the difference between the pressure P1 at the inlet of the reverse osmosis membrane apparatus and the pressure P2 at the concentrated water outlet thereof (P1−P2 (MPa)), as shown in FIG. 14. Even after 120 hours of water passage, the differential pressure was nearly constant and stable, thus confirming that clogging was prevented. Then, the differential pressure rose to 0.2 MPa, and water passage became impossible.

In connection with the water to be treated (raw water) which was introduced into the flocculation means 41, and treated water discharged from the reverse osmosis membrane apparatus 31 at 120 hours after the start of water passage of the water to be treated, the number of fine particles was measured with a particulate counter in the laser light shutoff mode, and the turbidity was determined by a transmitted light measuring method using a kaolin standard solution. The results are shown in Table 1. As shown in Table 1, suspended matter measuring 100 μm or more was removed in Example 4, indicating that the suspended matter was markedly removed as compared with Comparative Example 1 not using the filtration apparatus 10. In Example 4, therefore, it was confirmed that treated water discharged from the filtration apparatus 10 was clear and, as a result, membrane separation by the reverse osmosis membrane apparatus 31 in the subsequent stage was performed preferably.

### Example 5

The same procedure as in Example 4 was performed, except that the mixture of the water to be treated which was discharged from the reverse osmosis membrane apparatus 31 and air was passed for 10 minutes through the filtration apparatus 10 and the macrofiltration apparatus 20, once every 30 minutes, in the direction opposite to the water passage direction at a treated water flow rate of 1.6 m³/h and an air flow rate of 1.0 N m³/h.

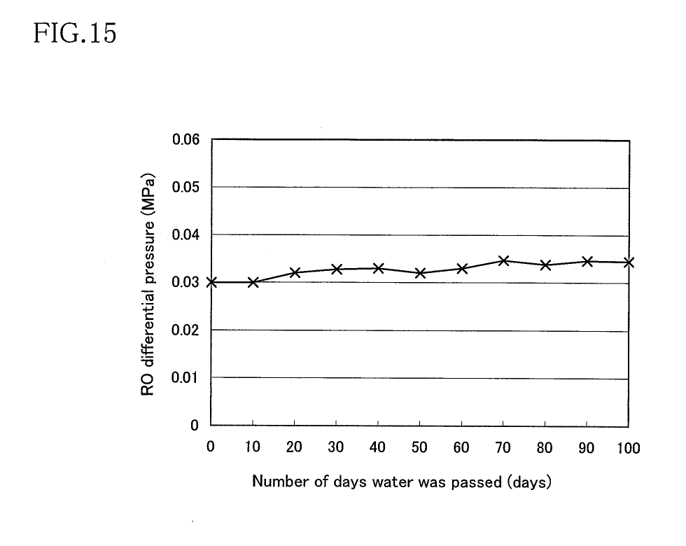

As a result, the differential pressure of the reverse osmosis membrane was nearly constant and stable even after 3 months of water passage, as shown in FIG. 15, thus confirming that clogging was prevented for a long period of time.

Reference examples showing the effects of the macrofiltration apparatus 20 will be indicated below.

(Relation Between the Void Content and an Increase in the Differential Pressure as Well as the Turbidity of Treated Water)

As water to be treated (raw water), industrial water having turbidity of 20 degrees was treated for a week at LV 200 m/h by use of a water treatment apparatus having the flocculation means 41 provided in the stage preceding the macrofiltration apparatus shown in FIG. 11. The filter used in the macrofiltration apparatus comprised the core material 23 and the string-shaped suspended matter trapping portions 24, and both ends of these components were fixed to the plates 26 disposed at both ends in the water passage direction of the macrofiltration tank 21, as shown in FIG. 11. The core material 23 had a volume of 250 mL, and each suspended matter trapping portion 24 was woven in a loop form into the core material such that its thickness was 0.5 mm, its width was 2 mm, and its length (distance of its loop end from the core material when the water to be treated was passed) was 100 mm. The filter was prepared, with the weaving density of the suspended matter trapping portion 24 being varied, such that the void contents of the filtration portion (the remainder after subtracting the volume of the core material 23 from the volume of the interior of the macrofiltration tank 21) during water passage were 30, 40, 50, 60, 70, 80, 90, 95 and 98%. Water treatment was performed using each of the resulting filters. Since the core material was fixed at both ends, the change in the volume of the filtration portion was nearly 0% when the volume during passage of the water to be treated and the volume on other occasion were compared. The size of the macrofiltration tank 21 was such that its diameter was 200 mm and its height was 500 mm. As a flocculant, 30 mg/L, with respect to the water to be treated, of polyaluminum chloride (PAC: 10% by weight, as Al₂O₃) and 0.7 mg/L, with respect to the water to be treated, of Kuribest E851 (produced by Kurita Water Industries Ltd.) as an amphoteric polymer flocculant were added. The turbidity of treated water discharged from the macrofiltration apparatus (treated water turbidity), and the rate of increase in the differential pressure of the macrofiltration apparatus (differential pressure increase rate) were measured, and the results are shown in Table 2. The turbidity of the treated water was determined by the transmitted light measuring method using a kaolin standard solution, and the differential pressure increase rate of the macrofiltration apparatus was determined by the pressure difference between the inlet and the outlet.

It was found that with the macrofiltration apparatus having the filter charged such that the void content of the filtration portion during water passage would become 50 to 95%, the differential pressure increase rate and the treated water turbidity were markedly low as compared with that having a void content outside the range of 50 to 95%, clear treated water was obtained, and clogging could be suppressed.

TABLE 2

Filter comprising core material and string-
shaped suspended matter trapping portions

| | Differential pressure | |
|---|---|---|
| Void | increase rate | Treated water turbidity |
| content % | (kPa/D) | (degrees) |
| 98 | 0 | 16 |
| 95 | 0 | 3.7 |
| 90 | 0 | 3 |
| 80 | 0 | 2.2 |
| 70 | 0.1 | 1.1 |
| 60 | 0.1 | 1.1 |
| 50 | 2 | 0.9 |
| 40 | 19 | 0.8 |
| 30 | 50 | 0.4 |

### Reference Example 1

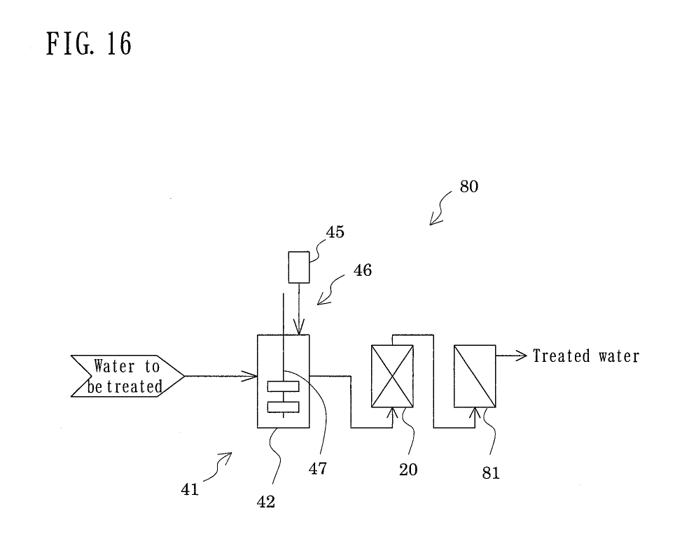

As water to be treated (raw water), industrial water having turbidity of 3.4 to 22 degrees, TOC (total organic carbon) of 0.3 to 4.8 mg/L, and a water temperature of 24.5 to 26.0° C. was treated at LV 200 m/h, with its water quality being changed periodically, by use of the apparatus shown in FIG. 16 (amount of raw water supplied: 50 L/h), concretely, a water treatment apparatus 80 having the flocculation means 41, macrofiltration apparatus 20, and membrane separation means 81 provided in this sequence from the upstream side. An MF membrane was used as a separation membrane of the membrane separation means 81. The turbidity of treated water discharged from the macrofiltration apparatus 20 and the differential pressure increase rate of the macrofiltration apparatus 20 were measured, and the results are shown in Table 3. The macrofiltration apparatus 20 had the filter comprising the core material 23 and the string-shaped suspended matter trapping portions 24, as shown in FIG. 11. Each suspended matter trapping portion 14 had a thickness of 0.5 mm, a width of 2 mm, and a length of 100 mm, and the void content of the filtration portion (macrofiltration tank 21) during water passage was 85%. Only one end of the core material 23 of the macro-filter 22 was fixed to the plate 26 disposed on the upstream side in the water passage direction. Although the other end of the core material 23 was not fixed, the one end thereof was fixed to the plate 26 on the upstream side. Thus, the filter spread nearly uniformly throughout the filtration tank during passage of the treated water. As a flocculant, polyaluminum chloride (PAC: 10% by weight, as Al₂O₃) was added in an amount of 30 mg/L to the water to be treated.

### Reference Example 2

The same procedure as in Reference Example 1 was performed, except that 2 to 5 slits were provided at locations other than those of the loop-shaped suspended matter trapping portions fixed to the core material.

### Reference Example 3

The same procedure as in Reference Example 2 was performed, except that both ends of the core material 23 of the macro-filter 22 were fixed to the plates 26 located on the upstream side and the downstream side in the water passage direction.

TABLE 3

| | Treated water | Differential pressure |
|---|---|---|
| | turbidity | increase rate |
| | (degrees) | (kPa/D) |
| Reference | 2.4-2.9 | 0.75 |
| Example 1 | | |
| Reference | 2.1-2.3 | 0.61 |
| Example 2 | | |
| Reference | 2.0-2.2 | 0.6 |
| Example 3 | | |

As shown in Table 3, it was found that in Reference Examples 1 to 3, the treated water turbidity and the differential pressure increase rate were low, clear treated water was obtained, and clogging of the macrofiltration apparatus did not occur. In Reference Example 2 having the slits provided in the filter, the treated water turbidity was lower, and the differential pressure increase rate was lower, than in Reference Example 1. In Reference Example 3 having both ends of the filter fixed to the filtration tank, the treated water turbidity was lower than in Reference Example 2 when the water to be treated had higher turbidity.

### EXPLANATIONS OF LETTERS OR NUMERALS

1 Filtration tank, 2 Filter, 3 Core material, 4 Filter body, 5 Mesh sheet, 6 Spacer, 7 Plate, 8 Water-impermeable member, 9a Warp thread, 9b Weft thread, 10 Filtration apparatus, Macrofiltration tank, 22 Macro-filter, 23 Core material, 24 Suspended matter trapping portion, 25 Slit, 26 Plate, 30, 40, 50, 60, 70, 80 Water treatment apparatus, 31 Reverse osmosis membrane apparatus, 41 Flocculation means, 42 Reaction tank, Chemical tank, 44 Chemical introduction means, 45 Inorganic flocculant tank, 46 Inorganic flocculant introduction means, 51 Absorbance measuring means, 52 Addition amount control means, Treated water tank, 62 Cleaning fluid introduction means, 63 to 66 Valve, 81 Membrane separation means

1. A filtration apparatus, comprising:
a filter body formed by spirally winding a sheet-shaped member; and
a filtration tank through which water to be treated is passed, and into which the filter body is charged such that an axis of the filter body extends along a direction of water passage,
wherein the sheet-shaped member is composed of a sheet-shaped mesh sheet having holes through which the water to be treated passes, and a sheet-shaped spacer through which the water to be treated passes with difficulty as compared with the mesh sheet, sheet surfaces of the mesh sheet and the spacer being superposed on each other.

2. The filtration apparatus according to claim 1, wherein the filter body is the sheet-shaped member spirally wound around a core material.

3. The filtration apparatus according to claim 1, wherein the spacer is a nonwoven fabric formed from fibers having a diameter of 0.1 to 100 μm.

4. The filtration apparatus according to claim 1, wherein the spacer is formed from activated carbon fibers having a diameter of 0.1 to 100 μm.

5. The filtration apparatus according to claim 1, wherein the spacer is composed of a nonwoven fabric formed from fibers having a diameter of 0.1 to 100 μm, and a water-impermeable sheet which is not permeable to the water to be treated.

6. The filtration apparatus according to claim 1, wherein the mesh sheet is formed from fibers having a diameter of 0.1 to 0.6 mm.

7. A water treatment apparatus having a reverse osmosis membrane apparatus in a stage succeeding the filtration apparatus according to claim 1.

8. The water treatment apparatus according to claim 7, which has, in a stage preceding the filtration apparatus, a macrofiltration apparatus comprising a macro-filter charged into a macrofiltration tank such that a void content of a filtration portion during water passage becomes 50 to 95%, the macro-filter having string-shaped suspended matter trapping portions and trapping suspended matter contained in the water to be treated which is being passed.

9. The water treatment apparatus according to claim 8, wherein the macrofiltration apparatus and the filtration apparatus are accommodated in a single vessel, and the macrofiltration apparatus and the filtration apparatus are integrated.

10. The water treatment apparatus according to claim 7, further comprising, in a stage preceding the filtration apparatus, flocculation means including a reaction tank into which the water to be treated is introduced, and flocculant introduction means which introduces a flocculant in the reaction tank or in a stage preceding the reaction tank to add the flocculant to the water to be treated.

11. The water treatment apparatus according to claim 7, further comprising cleaning fluid introduction means which introduces a cleaning fluid or a liquid mixture of the cleaning fluid and air at an arbitrary frequency and in a direction opposite to a direction during treatment.

12. The filtration apparatus according to claim 2, wherein the spacer is a nonwoven fabric formed from fibers having a diameter of 0.1 to 100 μm.

13. The filtration apparatus according to claim 2, wherein the spacer is formed from activated carbon fibers having a diameter of 0.1 to 100 μm.

14. The filtration apparatus according to claim 3, wherein the spacer is formed from activated carbon fibers having a diameter of 0.1 to 100 μm.

15. The filtration apparatus according to claim 2, wherein the spacer is composed of a nonwoven fabric formed from fibers having a diameter of 0.1 to 100 μm, and a water-impermeable sheet which is not permeable to the water to be treated.

16. The filtration apparatus according to claim 2, wherein the mesh sheet is formed from fibers having a diameter of 0.1 to 0.6 mm.

17. The filtration apparatus according to claim 3, wherein the mesh sheet is formed from fibers having a diameter of 0.1 to 0.6 mm.

18. The filtration apparatus according to claim 4, wherein the mesh sheet is formed from fibers having a diameter of 0.1 to 0.6 mm.

19. The filtration apparatus according to claim 5, wherein the mesh sheet is formed from fibers having a diameter of 0.1 to 0.6 mm.

20. A water treatment apparatus having a reverse osmosis membrane apparatus in a stage succeeding the filtration apparatus according to claim 2.
